(19) United States
(12) Patent Application Publication
(10) Pub. No.: US 2016/0126542 A1
(43) Pub. Date: May 5, 2016

(54) POSITIVE ACTIVE MATERIAL, POSITIVE ELECTRODE AND LITHIUM BATTERY INCLUDING THE POSITIVE ACTIVE MATERIAL, AND METHOD OF MANUFACTURING THE POSITIVE ACTIVE MATERIAL

(71) Applicant: Samsung SDI Co., Ltd., Yongin-si (KR)

(72) Inventors: Jungmin Han, Yongin-si (KR); Jaehong Lim, Yongin-si (KR); Yongchan You, Yongin-si (KR)

(21) Appl. No.: 14/704,652

(22) Filed: May 5, 2015

(30) Foreign Application Priority Data
Nov. 4, 2014 (KR) 10-2014-0152081

(51) Int. Cl. H01M 4/36; C01G 53/00; H01M 4/505; H01M 10/052; H01M 4/525; H01M 4/62

(52) U.S. Cl. CPC H01M 4/366; H01M 4/525; H01M 4/62; H01M 4/505; H01M 10/052; C01G 53/44; H01M 2004/028

(57) ABSTRACT

A positive active material, a method of preparing the positive active material, a positive electrode including the positive active material, and a lithium battery including the positive active material are disclosed. The positive active material includes a core including a lithium metal composite oxide and a coating layer formed on the core. The coating layer includes at least one of lithium fluoride (LiF) and lithium phosphate (Li₃PO₄). In this regard, the coating layer may improve the stability of the positive active material, and accordingly, the lifespan properties of a lithium battery including the positive active material may be improved.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of Korean Patent Application No. 10-2014-0152081, filed on Nov. 4, 2014, in the Korean Intellectual Property Office, the disclosure of which is incorporated herein in its entirety by reference.

### BACKGROUND

1. Field

One or more embodiments of the present disclosure relate to a positive active material, a positive electrode and a lithium battery that include the positive active material, and a method of manufacturing the positive active material.

2. Description of the Related Technology

With the advancement of small high tech devices such as digital cameras, mobile devices, notebook computers, and personal computers, the demand for lithium secondary batteries, which are energy sources for the small high tech devices, has dramatically increased. Also, stable lithium ion batteries having high capacity are currently being developed for hybrid electric vehicles (HEV), plug-in hybrid electric vehicles (PHEV), and electric vehicles (EV).

Various positive active materials are currently being studied to develop a lithium battery that is suitable for the purposes described above

As a positive active material for a lithium secondary battery, a single-component lithium cobalt oxide (LiCoO₂) is primarily used or utilized; however, use or utilization of lithium composite metal oxides (e.g., Li(Ni—Co—Mn)O₂, Li(Ni—Co—Al)O₂, etc.) having layered-structures and high capacity has been increasing. Also, a spinel-structured lithium manganese oxide (LiMn₂O₄) and an olivine-structured iron phosphate lithium oxide (LiFePO₄) having high safety features are receiving attention.

In particular, research is being conducted to increase the amount of nickel included in the lithium composite metal oxide to increase the capacity of the battery and represent excellent rate property of the battery.

Accordingly, a method of improving lifespan properties of a lithium battery including the positive active material including a large amount of nickel is needed.

### SUMMARY

Some embodiments include a positive active material having free lithium in a reduced amount and having improved stability, in which a coating layer including at least one of lithium fluoride (LiF) and lithium phosphate (Li₃PO₄) is disposed on a surface of a core.

Some embodiments include a positive electrode including the positive active material.

Some embodiments include a lithium battery including the positive electrode and having improved lifespan properties.

Some embodiments include a method of preparing the positive active material.

Additional embodiments will be set forth in part in the description which follows and, in part, will be apparent from the description, or may be learned by practice of the presented embodiments.

According to one or more exemplary embodiments, a positive active material includes: a core including a lithium metal composite oxide; and a coating layer disposed on the core. The coating layer may include at least one of lithium fluoride (LiF) and lithium phosphate (Li₃PO₄).

In an exemplary embodiment, the positive active material may include free lithium in an amount of about 10,000 ppm or less based on a total weight of the positive active material.

In an exemplary embodiment, the lithium metal composite oxide may include a lithium-nickel composite oxide, in which an amount of nickel may be at least 60 mole % based on a total number of moles of metal atoms except for lithium (i.e., excluding the number of moles for lithium) in the lithium-nickel composite oxide.

In an exemplary embodiment, the lithium metal composite oxide may include a lithium-nickel composite oxide represented by Formula 1 below:

Liₐ(NiₓM′_{y}M″_{z})O₂ Formula 1

In Formula 1, M′ may be at least one of Co, Mn, Ni, Al, Mg, and Ti; and M″ may be at least one of Ca, Mg, Al, Ti, Sr, Fe, Co, Mn, Ni, Cu, Zn, Y, Zr, Nb, and B, where 0.8<a≦1.2, 0.6≦x≦1, 0≦y≦0.4, 0≦z≦0.4, and x+y+z≦1.2.

According to one or more exemplary embodiments, a positive electrode includes the positive active material.

According to one or more exemplary embodiments, a lithium battery includes the positive electrode.

According to one or more exemplary embodiments, a method of manufacturing the positive active material includes: providing a core that includes a lithium metal composite oxide including free lithium; and coating a surface of the core with at least one of a fluoride compound and a phosphate compound to form a coating layer including at least one of LiF and Li₃PO₄.

LiF may be formed by a reaction between the free lithium and the fluoride compound while Li₃PO₄ may be formed by a reaction between the free lithium and the phosphate compound.

In an exemplary embodiment, the fluoride compound may include NH₄F, NH₄HF₂, NH₄PF₆, AlF₃, MgF₂, CaF₂, MnF₃, FeF₃, CoF₂, CoF₃, NiF₂, TiF₄, CuF, ZnF₂, or a combination thereof. The phosphate compound may include NH₄H₂PO₄, (NH₄)₂HPO₄, P₂O₃, P₂O₅, H₃PO₄, MgHPO₄, Mg₃(PO₄)₂, Mg(H₂PO₄)₂, NH₄MgPO₄, AlPO₄, FePO₄, Zn₃(PO₄)₂, or a combination thereof.

In an exemplary embodiment, the forming of the coating layer may further sequentially include heat-treating the core on which the coating layer is formed.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of a structure of a positive active material according to an exemplary embodiment;

FIG. 2 is a schematic view of a structure of a positive active material according to another exemplary embodiment;

FIG. 3 is a schematic cross-sectional perspective view of a structure of a lithium battery according to an exemplary embodiment;

FIG. 4 is a graph comparing the amounts of free lithium of the positive active materials manufactured in Examples 1-4 and 6-9 and Comparative Examples 1-4 according to a heat treatment temperature;

FIG. 5 is a graph comparing the decreased amounts of free lithium of the positive active materials manufactured in Examples 1-4 and 6-9 and Comparative Examples 1-4 according to a heat treatment temperature;

FIG. 6 is a graph of the XRD measurements of the positive active materials manufactured in Example 1;

FIG. 7 is a graph of the XRD measurements of the positive active materials manufactured in Example 6;

FIG. 8 is a graph comparing the X-ray photoelectron spectroscopy (XPS) measurements of the positive active materials manufactured in Examples 1, 3, 6, 8, and 9, and Comparative Examples 1 and 3;

FIG. 9 is a graph comparing the F (1s) peaks with respect to the XPS measurements of the positive active materials manufactured in Examples 1 and 3;

FIG. 10 is a graph comparing the P(2p) peaks with respect to the XPS measurements of the positive active materials manufactured in Examples 6, 8 and 9; and

FIG. 11 is a graph comparing the C (1s) peaks with respect to the XPS measurements of the positive active materials manufactured in Examples 1, 3, 6, 8, and 9.

### DETAILED DESCRIPTION

Reference will now be made to certain embodiments, examples of which are illustrated in the accompanying drawings, where like reference numerals refer to like elements throughout. In this regard, the presented embodiments may take different forms and should not be construed as being limited to the descriptions set forth herein. Accordingly, the presented embodiments are described below by referring to the figures to explain certain aspects of the present description. As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Additional aspects will be set forth in part in the description which follows and, in part, will be apparent from the description, or may be learned by practice of the presented embodiments.

In general, a greater amount of nickel included in a positive active material denotes a greater number of Ni²⁺ to carry out substitution at a lithium position. In this regard, impurities, such as NiO, may be easily produced. Due to great reactivity of NiO, the NiO produced herein may easily react with an electrolyte, and then, may be connected to each other to form a local three-dimensional structure, which hinders the diffusion of lithium ions. Accordingly, a battery may have low structural stability as well as small capacity.

In order to manufacture a lithium metal composite oxide having a large amount of nickel, excessive use of Li₂CO₃ is required, and accordingly, much of remaining lithium exist on a surface of the manufactured lithium metal composite oxide by Li₂CO₃. The remaining lithium, i.e., free lithium, may produce a base containing LiOH or Li₂CO₃ by a reaction with water or CO₂, and such a base may react with an electrolyte, thereby generating CO₂ gas. In this regard, an internal pressure of a battery increases, which may degrade lifespan and stability properties of a battery.

Accordingly, in the present disclosure, amount of free lithium is decreased in a positive active material containing a large amount of nickel to thereby develop a battery with enhanced lifespan properties.

In particular, a positive active material according to an exemplary embodiment includes a core including a lithium metal composite oxide core; and a coating layer disposed on the core. The coating layer includes at least one of lithium fluoride (LiF) and lithium phosphate (Li₃PO₄).

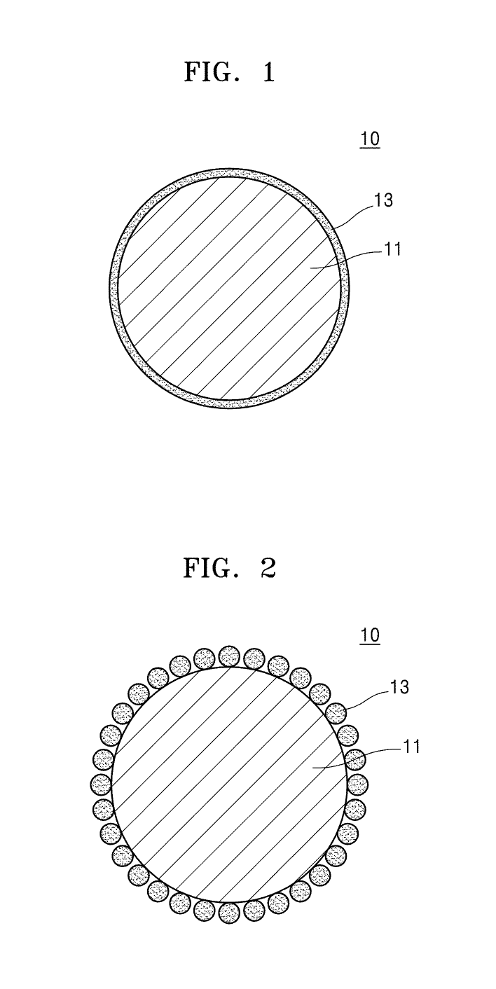

FIG. 1 is a schematic view of a structure of a positive active material 10 according to an exemplary embodiment, and FIG. 2 is a schematic view of a structure of a positive active material 10 according to another exemplary embodiment. As shown in FIGS. 1 and 2, a coating layer 13 including at least one of LiF and Li₃PO₄ is disposed on a core 11 included in the positive active material 10.

Referring to FIG. 1, the coating layer 13 may be a continuous coating layer. As used herein, the term “continuous coating layer” refers to a coating layer in which the core is completely coated (i.e., the coating layer covers the entire core 11).

Referring to FIG. 2, the coating layer 13 may be an island-type discontinuous coating layer. As used herein, the term “island”-type refers to spherical, hemispherical, non-spherical, or irregular shape, each with a predetermined volume, but the shape of the coating layer 13 is not particularly limited thereto. As shown in FIG. 2, the island-type coating layer 13 may include spherical particles that are discontinuously coated, or may include several particles that have an irregular shape by combining themselves together with a constant volume.

LiF and Li₃PO₄ of the coating layer may be inactive materials in which intercalation/deintercalation of Li ions does not occur. In this regard, the coating layer including LiF and/or Li₃PO₄ may not react with an electrolyte, and may inhibit a side reaction between a positive active material and an electrolyte due to electron transfer between the core 11 and an electrolyte. In addition, the coating layer 13 including LiF and/or Li₃PO₄ becomes integrated with the core 11 to prevent side reactions (such as elution of a transition metal at a high temperature or gas generation at high voltage). Furthermore, during charge and discharge of a battery, structural changes to the surface of the positive active material, due to the presence of the coating layer 13, may be prevented to thereby improve the stability and lifespan properties of the lithium battery including the positive active material.

The core of the positive active material may be any suitable material generally used as a positive active material in the art. For example, the core may include any compound represented by any one of the following formulae: LiₐA_{1-b}B¹_{b}D¹₂ (where 0.90≦a≦1 and 0≦b≦0.5); LiₐE_{1-b}B¹_{b}O_{2-c}D¹_{c} (where 0.90≦a≦1, 0≦b≦0.5, and 0≦c≦0.05); LiE_{2-b}B¹_{b}O_{4-c}D¹_{c} (where 0≦b≦0.5 and 0≦c≦0.05); LiₐNi_{1-b-c}Co_{b}B¹_{c}D¹_{α} (where 0.90≦a≦1, 0≦b≦0.5, 0≦c≦0.05, and 0<α≦2); LiₐNi_{1-b-c}Co_{b}B¹_{c}O_{2-α}F_{α} (where 0.90≦a≦1, 0≦b≦0.5, 0≦c≦0.05, and 0<α<2); LiₐNi_{1-b-c}Co_{b}B¹_{c}O_{2-α}F₂ (where 0.90≦a≦1, 0≦b≦0.5, 0≦c≦0.05, and 0<α<2); LiₐNi_{1-b-c}Mn_{b}B¹_{c}D¹_{α} (where 0.90≦a≦1, 0≦b≦0.5, 0≦c≦0.05, and 0<α≦2); LiₐNi_{1-b-c}Mn_{b}B¹_{c}O_{2-α}F_{α} (where 0.90≦a≦1, 0≦b≦0.5, 0≦c≦0.05, and 0<α<2); LiₐNi_{1-b-c}Mn_{b}B¹_{c}O_{2-α}F₂ (where 0.90≦a≦1, 0≦b≦0.5, 0≦c≦0.05, and 0<α<2); LiₐNi_{b}E_{c}G_{d}O₂ (where 0.90≦a≦1, 0≦b≦0.9, 0≦c≦0.5, and 0.001≦d≦0.1); LiₐNi_{b}Co_{c}Mn_{d}GeO₂ (where 0.90≦a≦1, 0≦b≦0.9, 0≦c≦0.5, 0≦d≦0.5, and 0.001≦e≦0.1); LiₐNiG_{b}O₂ (where 0.90≦a≦1 and 0.001≦b≦0.1); LiₐCoG_{b}O₂ (where 0.90≦a≦1 and 0.001≦b≦0.1); LiₐMnG_{b}O₂ (where 0.90≦a≦1 and 0.001≦b≦0.1); LiₐMn₂G_{b}O₄ (where 0.90≦a≦1 and 0.001≦b≦0.1); QO₂; QS₂; LiQS₂; V₂O₅; LiV₂O₅; LiIO₂; LiNiVO₄; Li_{(3-f)}J₂(PO₄)₃ (0≦f≦2); Li_{(3-f)}Fe₂(PO₄)₃ (0≦f≦2); and LiFePO₄.

In the formulae above, A may be nickel (Ni), cobalt (Co), manganese (Mn), or a combination thereof; B¹ may be aluminum (Al), Ni, Co, Mn, chromium (Cr), iron (Fe), Mg, strontium (Sr), vanadium (V), a rare earth metal element, or a combination thereof; D¹ may be oxygen (O), fluorine (F), sulfur (S), phosphorus (P), or a combination thereof; E may be Co, Mn, or a combination thereof; X may be F, S, P, or a combination thereof; G may be Al, Cr, Mn, Fe, Mg, lanthanum (La), cerium (Ce), Sr, V, or a combination thereof; Q may be Ti, molybdenum (Mo), Mn, or a combination thereof; L may be Cr, V, Fe, Sc, Y, or a combination thereof; and J may be V, Cr, Mn, Co, Ni, Cu, or a combination thereof.

For example, the positive active material may include LiCoO₂, LiMnₓO₂ₓ (x=1 and 2), LiNi₁₋ₓMnₓO₂ₓ (0<x<1), LiNi_{1-x-y}CoₓMn_{y}O₂ (0≦x≦0.5 and 0≦y≦0.5), FePO₄, and the like.

The compounds (for the core of the positive active material) may have a coating layer formed on a surface thereof or may be mixed with a compound having a coating layer. The coating layer may include a coating element compound (a compound of a coating element), such as an oxide of a coating element, a hydroxide of a coating element, an oxyhydroxide of a coating element, an oxycarbonate of a coating element, or a hydroxycarbonate of a coating element. The compounds that form the coating layer may be amorphous or crystalline. As a coating element included in the coating layer, Mg, Al, Co, K, Na, Ca, Si, Ti, V, Sn, germanium (Ge), gallium (Ga), boron (B), arsenic (As), Zr, or a mixture thereof may be utilized. The coating layer may be formed utilizing any one of various suitable coating methods that are performed utilizing the compounds and the elements, and that do not adversely affect the properties of the positive active material. For example, spray coating, immersion, or the like, may be utilized. These coating methods are known to those of ordinary skill in the art.

According to an embodiment, the lithium metal composite oxide may include a lithium-nickel composite oxide. For example, due to the formation of the coating layer, the lithium metal composite oxide may include a large amount of nickel, which may increase the capacity of the battery. According to an exemplary embodiment, an amount of nickel in the lithium-nickel composite oxide may be at least 60 mole %, for example, in a range of about 70 mole % to about 90 mole %, based on a total number of moles of metal elements excluding lithium included in the lithium-nickel composite. The positive active material including a large amount of nickel may include lithium in a decreased amount, and accordingly, the stability of the positive active material may be improved to thereby have high capacity.

The lithium metal composite oxide of the positive active material may include a lithium-nickel composite oxide represented by Formula 1 below:

Liₐ(NiₓM′_{y}M″_{z})O₂ Formula 1

In Formula 1, M′ may be at least one element selected from the group consisting of Co, Mn, Ni, Al, Mg, and Ti; M″ may be at least one element selected from the group consisting of Ca, Mg, Al, Ti, Sr, Fe, Co, Mn, Ni, Cu, Zn, Y, Zr, Nb, and B; and 0.8<a≦1.2, 0.6≦x≦1; 0≦y≦0.4; 0≦z≦0.4, and x+y+z≦1.2.

For example, the lithium metal composite oxide may include a lithium-nickel composite oxide represented by Formula 2 below:

Liₐ(NiₓCo_{y}Mn_{z})O₂ Formula 2

In Formula 2, 0.8<a≦1.2, 0.6≦x≦1, 0≦y≦0.4, 0≦z≦0.4, and x+y+z≦1.2.

A 3-component-based lithium-nickel-cobalt-manganese oxide represented by Formula 2 above may include a combination of high capacity provided by a lithium-nickel oxide, thermal stability and economic feasibility provided by a lithium-manganese oxide, and stable electrochemical properties provided by a lithium-cobalt oxide, thereby exhibiting good battery properties.

When the core includes the lithium metal composite oxide, there may be a free lithium remained on a surface of the lithium metal composite oxide.

As used herein, the term “free lithium” refers to lithium that is dissolved in a solvent, e.g., water, due to a thermodynamically unstable property thereof and remains on a surface of a lithium metal composite oxide. That is, the free lithium does not refer to lithium that is included in a lithium metal composite oxide contributing to the capacity of the battery. An amount of the free lithium is calculated by an amount of impurities on a surface of a lithium transition metal oxide, e.g., LiOH and/or Li₂CO₃. The amount of impurities is obtained by dispersing or dissolving the positive active material in a solvent and by titrating the resulting mixture with acid.

When the amount of the free lithium is more than a certain level, the reactivity of the positive active material with respect to an electrolyte is increased as described above. In this regard, the battery may be expanded or the lifespan characteristics thereof may be degraded.

In an exemplary embodiment, the positive active material may include free lithium in an amount of about 10,000 ppm or less based on a total weight of the positive active material. For example, the positive active material may include free lithium in an amount of about 9,000 ppm or less based on a total weight of the positive active material. For example, the positive active material may include free lithium in an amount of about 8,000 ppm or less based on a total weight of the positive active material. When free lithium is contained in these ranges above, the reactivity of the positive active material with respect to an electrolyte may be decreased or the lifespan characteristics thereof may be improved.

LiF and/or Li₃PO₄ included in the coating layer may be a resultant product obtained by a reaction between free lithium on a surface of the core and a material added for the formation of the coating layer. That is, the amount of free lithium included in the positive active material may refer to an amount of free lithium excluding an amount of lithium consumed to produce LiF and/or Li₃PO₄ from an amount of free lithium on a surface of the core before the formation of the coating layer. Therefore, free lithium on a surface of the core before the formation of the coating layer is consumed in the process of producing LiF and/or Li₃PO₄ so that, after the formation of the coating layer, the amount of free lithium may be decreased to about 10,000 ppm or less based on a total weight of the positive active material.

The amount of the coating layer in the positive active material may be in a range of about 0.1 to about 10 parts by weight based on 100 parts by weight of the core, and for example, in a range of about 0.1 to about 5 parts by weight based on 100 parts by weight of the core. When the amount of the coating layer is within these ranges above, the amount of the coating layer may be sufficient to suppress structural changes to the surface of the positive active material. Accordingly, a side reaction between the positive active material and an electrolyte may be prevented. In addition, the amount of the core in the positive active material may be greater than a threshold amount, thereby preventing a decrease in capacity of the positive active material. Accordingly, implementation of an increase in capacity with certain levels and improved structural stability may be simultaneously achieved.

Hereinafter, a method of preparing the positive active material, according to another aspect, will be described.

According to an exemplary embodiment, a method of preparing the positive active material includes: providing the core that includes the lithium metal oxide including free lithium; and coating a surface of the core with at least one of a fluoride compound and a phosphate compound to form a coating layer including at least one of LiF and Li₃PO₄.

In an example, LiF may be a resultant product by a reaction between free lithium and the fluoride compound, and Li₃PO₄ may be a resultant product by a reaction between free lithium and the phosphate compound.

For example, free lithium may exist in the form of a base, such as LiOH or Li₂CO₃. Such a base is easily dissolved in a solvent, e.g., water, so that free lithium in the solvent may exist in the form of a free lithium ion (Li⁺).

The fluoride compound is not particularly limited, so long as a material includes fluoride. For example, the fluoride compound may be in the form of a salt including fluoride. In detail, the fluoride compound is dissociated in a solvent, e.g., water, to a fluoride anion (F⁻) and its counter ion. Similarly, the phosphate compound is not particularly limited, so long as a material includes phosphate. For example, the phosphate compound may be in the form of a salt including phosphate. In detail, the phosphate compound is dissociated in a solvent, for example, water, to a phosphate anion (PO₄³⁻) and its counter ion.

Therefore, free Li⁺ may react with F⁻ to form LiF, or free Li⁺ may react with PO₄³⁻ to form Li₃PO₄. These reactions may easily occur at room temperature, due to high reactivity of free lithium. Thus, additional heat treatment is not required herein.

In detail, the fluoride compound and/or the phosphate compound may be an inorganic material. In this regard, the coating layer may not include a carbonaceous material. For example, the coating layer may not include amorphous and/or low-crystalline carbonaceous material, which is produced by carbonization of an organic material.

For example, non-limiting examples of the fluoride compound are NH₄F, NH₄HF₂, NH₄PF₆, AlF₃, MgF₂, CaF₂, MnF₃, FeF₃, CoF₂, CoF₃, NiF₂, TiF₄, CuF, and ZnF₂, or a combination thereof.

For example, non-limiting examples of the phosphate compound are NH₄H₂PO₄, (NH₄)₂HPO₄, P₂O₃, P₂O₅, H₃PO₄, MgHPO₄, Mg₃(PO₄)₂, Mg(H₂PO₄)₂, NH₄MgPO₄, AlPO₄, FePO₄, and Zn₃(PO₄)₂, or a combination thereof.

For example, organic materials may include a polymer component of a long carbon chain, requiring an additional process to remove various types of gas, which may be caused by combustion of such a polymer component. However, in a case of using the inorganic fluoride compound and/or the inorganic phosphate compound, heat treatment is not required unlike a case where organic materials requires heat treatment for the coating process. Furthermore, even if the inorganic materials are heat-treated, these inorganic materials do not cause the carbide, that has high reactivity to an electrolyte due to high specific surface area thereof, on a surface of the positive active material. In this regard, these inorganic materials may be capable of preventing a side reaction between highly reactive carbide with an electrolyte.

The amount of the fluoride compound and/or the phosphate compound may be in a range of about 0.01 to about 10 parts by weight, for example, about 0.1 to about 5 parts by weight, based on 100 parts by weight of the core. For example, the amount of the fluoride compound and/or the phosphate compound may be in a range of about 0.5 to about 3 parts by weight based on 100 parts by weight of the core. When the amount of the fluoride compound and/or the phosphate compound is within these ranges, the capacity of the battery may be implemented with certain levels and the amount of free lithium may be reduced in an efficient manner. In addition, a surface of the core may be sufficiently covered by the coating layer that includes LiF and/or Li₃PO₄.

The lithium metal composite oxide of the core may include a lithium-nickel composite oxide represented by Formula 1 below:

Liₐ(NiₓM′_{y}M″_{z})O₂ Formula 1

In Formula 1, M′ is at least one of Co, Mn, Ni, Al, Mg, or Ti; M″ is at least one of Ca, Mg, Al, Ti, Sr, Fe, Co, Mn, Ni, Cu, Zn, Y, Zr, Nb, or B; 0.8<a≦1.2; 0.6≦x≦1; 0≦y≦0.4; 0≦z≦0.4; and x+y+z≦1.2.

For example, the lithium metal composite oxide may include a lithium-nickel composite oxide represented by Formula 2 below:

Liₐ(NiₓCo_{y}Mn_{z})O₂ Formula 2

In Formula 2, 0.8<a≦1.2, 0.6≦x≦1, 0≦y≦0.4, 0≦z≦0.4, and x+y+z≦1.2.

In an exemplary embodiment, the providing of the core may not further include washing the core.

The lithium metal composite oxide may include free lithium on a surface of the composite. In order to prevent adverse effects of the free lithium ion on the battery properties, the lithium metal oxide is washed out. In addition, in the case of modification of the surface of the core that includes the lithium metal composite oxide, the washing of the core is required to remove the free lithium and other impurities.

However, the free lithium included in the lithium metal oxide may react with the fluoride compound and/or phosphate compound during the coating process so that the amount of the free lithium may be reduced. In this regard, the washing of the core is not additionally required. That is, a possibility of removing lithium, which is involved in a reaction of a battery, by washing may be excluded by skipping the washing process, and such a process with one reduced step may be financially advantageous. In detail, the free lithium may contribute to forming a coating layer, and thus, when the free lithium is contained in a large amount in accordance with a large amount of nickel in the lithium-nickel metal composite oxide, the washing of the core may be omitted.

In an exemplary embodiment, the coating layer may be formed by a wet coating method.

When the coating layer is formed by a wet coating method, the coating of the surface of the core may further include preparing a coating solution including the fluoride compound and/or the phosphate compound; and coating a surface of the core with the coating solution.

The coating solution may be prepared by mixing the fluoride compound and/or the phosphate compound in a solvent. The coating solution may be, for example, in a solution form where the fluoride compound and/or the phosphate compound are dissolved in a solvent. The solvent is not particularly limited, and any solvent capable of dissolving the fluoride compound and/or the phosphate compound may be used. For example, the solvent may be water, ethanol, or methanol.

Next, the coating solution is mixed with the core so that a surface of the core is coated with the coating solution. The coating solution may be mixed with the core in a stirrer for about 10 minutes to about 12 hours. Afterwards, the coated core may be dried at a temperature of about 50° C. to about 200° C. for about 6 to 48 hours, so that the residual solvent may be removed.

Alternatively, the coating layer may be formed by a dry coating method. According to a dry coating method, unlike the wet coating method, a mechanical energy is applied to the core to form a coating layer. Such a dry coating method may not require an additional solvent. In addition, the mechanical energy applied thereto may cause pulverization and coating at the same time. In this regard, the core may maintain its sphericity while the coating layer is formed on the core.

The dry coating method includes a) a method of combining nanoparticles and the core that are mechanically bound to each other by which the nanoparticles are bound to the surface of the core by using a grinding device, according to motion of a rotor inside an apparatus, and/or by stress accompanying the nanoparticles, and by which heat generated by the stress is used to soften or melt the nanoparticles and the core, b) a method of forming a coating layer by which the nanoparticles contact to the surface of the core by the low-speed ball mill or the like, and the nanoparticles attached to the surface of the core are condensed with each other to form a coating layer, or a method of heat-treating the core including the coating layer of Method a) and/or Method b), melting and cooling all of or a partial of the coating layer and the core, or the like. However, these methods are not limited thereto, and any dry method known in the art may be used.

For example, the dry coating may be performed by using various methods, such as mechanofusion, planetary ball mill, low-speed ball mill, and high-speed ball mill, or a hybridization thereof.

According to the dry coating method, the coating layer may be formed as a continuous coating layer or an island-type coating layer depending on coating time, particle size of the positive active material, and other conditions that vary to avoid a form of a simple mixture.

In an exemplary embodiment, the forming of the coating layer may be followed by heat-treating the core on which the coating layer is formed. When the core including the coating layer is heat-treated in an air atmosphere, a positive active material in which the coating layer is integrated with the core may be obtained.

For example, the heat treatment may be performed at a temperature of 700° C. or less. For example, the heat treatment may be performed at a temperature of 500° C., for example, a temperature in a range of 100° C. to 400° C., and for example, at a temperature in a range of 100° C. to 300° C. When the temperature is within these ranges, the reactivity between the free lithium and the fluoride compound and/or the phosphate compound becomes maximized, and accordingly, the deintercalation of lithium of the lithium metal composite oxide may be prevented to achieve a certain level of a battery capacity.

According to another embodiment, a positive electrode includes the positive active material described above.

The positive electrode may, for example, be manufactured by mixing the positive active material, a binder, and optionally, a conductor in a solvent to prepare a positive electrode slurry, which may then be molded into a certain shape or spread on a current collector (such as aluminum).

The binder used (utilized) in the positive electrode slurry is a component that facilitates binding of the positive active material to the conductor, and binding of the positive active material to the current collector. The binder may be added in an amount of about 1 part by weight to about 50 parts by weight based on 100 parts by weight of the positive active material. For example, the binder may be added in an amount of about 1 part by weight to about 30 parts by weight, about 1 part by weight to about 20 parts by weight, or about 1 part by weight to about 15 parts by weight, based on 100 parts by weight of the positive active material. The binder may be selected from polyvinylidene fluoride (PVdF), polyvinylidene chloride, polybenzimidazole, polyimide, polyvinyl acetate, polyacrylonitrile, polyvinyl alcohol, carboxymethyl cellulose (CMC), starch, hydroxypropyl cellulose, regenerated cellulose, polyvinylpyrrolidone, tetrafluoroethylene, polyethylene, polypropylene, polystyrene, polymethyl methacrylate, polyaniline, acrylonitrile-butadiene-styrene, phenolic resin, epoxy resin, polyethylene terephthalate, polytetrafluoroethylene, polyphenylene sulfide, polyamide-imide, polyetherimide, polyethylene sulfone, polyamide, polyacetal, polyphenylene oxide, polybutylene terephthalate, ethylene-propylene-diene monomer (EPDM), sulfonated EPDM, styrene butadiene rubber (SBR), fluororubber, and a combination thereof, but the binder is not limited thereto.

The positive electrode provides a conductive pathway to the positive active material, and may selectively (optionally) further include a conductor that may improve the electrical conductivity. The conductor may be any suitable conductor generally used (utilized) in a lithium battery, and non-limiting examples thereof include carbonaceous materials (such as carbon black, acetylene black, Ketjen black, carbon fiber, or the like); metallic materials (such as a metal powder or metal fiber of copper, nickel, aluminum, or silver); conductive polymers (such as polyphenylene derivatives); and mixtures thereof. The amount of the conductor may be appropriately controlled. For example, the conductor may be added in such an amount that a weight ratio of the positive active material to the conductor is in about 99:1 to about 90:10.

The solvent may be N-methylpyrrolidone (NMP), acetone, water, or the like. An amount of the solvent may be about 1 part by weight to about 40 parts by weight based on 100 parts by weight of the positive active material. When the amount of the solvent is in the range described above, the process of forming the active material layer may be easy.

Also, the current collector may typically have a thickness of about 3 μm to about 500 μm. The current collector is not particularly limited as long as the current collector does not cause a chemical change in the battery and has suitable electrical conductivity. Non-limiting examples of the material for the current collector include copper, stainless steel, aluminum, nickel, titanium, calcined carbon, copper and stainless steel that are surface-treated with carbon, nickel, titanium, silver, or the like, an alloy of aluminum and cadmium, etc. Also, an uneven microstructure may be present on the surface of the current collector to enhance the binding strength of the positive active material. Also, the current collector may take various forms including a film, a sheet, a foil, a net, a porous structure, a foam structure, a non-woven structure, etc.

An aluminum current collector may be directly coated with the prepared positive electrode slurry; or the positive electrode slurry may be cast on a separate support, and then the positive active material film may be peeled off of the support and laminated on the aluminum current collector, which is then dried and pressed, and heat-treated under vacuum at a temperature of about 50° C. to about 250° C. to prepare a positive electrode. However, the positive electrode is not limited to the above and may have a shape other than the shape described above.

According to another embodiment, a lithium battery includes a positive electrode including the positive active material. For example, the lithium battery includes a positive electrode including the positive active material; a negative electrode facing the positive electrode; a separator between the positive electrode and the negative electrode; and an electrolyte. The lithium battery may be manufactured according to the following method.

First, a positive electrode is manufactured according to the manufacturing method of the positive electrode described above.

Then, a negative electrode may be manufactured in the same manner as the positive electrode, except that a negative active material is used (utilized) instead of the positive active material. Also, in the negative electrode slurry, the binder, conductor, and solvent may be the same as those used (utilized) in the positive electrode.

For example, the negative active material, the binder, the conductor, and the solvent may be mixed to prepare a negative electrode slurry, which may then be directly coated on a copper current collector to manufacture a negative electrode plate. Alternatively, the negative electrode slurry may be cast on a separate support, and the negative active material film may be peeled off of the support and laminated on the copper current collector to manufacture the negative electrode plate.

The negative active material may be any suitable negative active material for a lithium battery known in the art. For example, the negative active material may be at least one of a lithium metal, a metal alloyable with lithium, a transition metal oxide, a non-transition metal oxide, and a carbonaceous material.

For example, the metal alloyable with lithium may include Si, Sn, Al, Ge, Pb, Bi, Sb, a Si—Y alloy (where Y is an alkali metal, an alkaline earth metal, a Group 13 element, a Group 14 element, a transition metal, a rare earth metal element, or a combination thereof, but Y is not Si), or a Sn—Y alloy (where Y is an alkali metal, an alkaline earth metal, a Group 13 element, a Group 14 element, a transition metal, a rare earth metal element, or a combination thereof, but Y is not Sn). In some embodiments, the element Y may be magnesium (Mg), calcium (Ca), strontium (Sr), barium (Ba), radium (Ra), scandium (Sc), yttrium (Y), titanium (Ti), zirconium (Zr), hafnium (Hf), rutherfordium (Rf), vanadium (V), niobium (Nb), tantalum (Ta), dubnium (Db), chromium (Cr), molybdenum (Mo), tungsten (W), seaborgium (Sg), technetium (Tc), rhenium (Re), bohrium (Bh), iron (Fe), lead (Pb), ruthenium (Ru), osmium (Os), hassium (Hs), rhodium (Rh), iridium (Ir), palladium (Pd), platinum (Pt), copper (Cu), silver (Ag), gold (Au), zinc (Zn), cadmium (Cd), boron (B), aluminum (Al), gallium (Ga), tin (Sn), indium (In), titanium (Ti), germanium (Ge), phosphorus (P), arsenic (As), antimony (Sb), bismuth (Bi), sulfur (S), selenium (Se), tellurium (Te), polonium (Po), or a combination thereof.

For example, the transition metal oxide may include a lithium titanium oxide, a vanadium oxide, a lithium vanadium oxide, or the like.

For example, the non-transition metal oxide may include SnO₂, SiOₓ

(0<x<2), or the like.

The carbonaceous material may include a crystalline carbon, an amorphous carbon, or a combination thereof. Non-limiting examples of the crystalline carbon include graphite (such as natural graphite or synthetic graphite) having an irregular, flat, flake, spherical, or fiber shape. Non-limiting examples of the amorphous carbon include soft carbon, hard carbon, mesophase pitch carbide, and calcined coke.

Then, a separator to be disposed between the positive electrode and the negative electrode is prepared. The separator may be any suitable separator that is generally used (utilized) in a lithium battery. For example, the separator may include a material that has low resistance to the migration of ions from the electrolyte and good electrolytic solution-retaining capability. For example, the separator may include a material such as glass fiber, polyester, Teflon, polyethylene, polypropylene, polytetrafluoroethylene (PTFE), or a combination thereof, each of which may be nonwoven or woven. The separator may have a pore size of about 0.01 μm to about 10 μm, and a thickness of about 5 μm to about 300 μm.

The electrolyte may include a non-aqueous electrolyte and a lithium salt. Non-limiting examples of the non-aqueous electrolyte include a non-aqueous electrolytic solution, an organic solid electrolyte, an inorganic solid electrolyte, etc.

As the non-aqueous electrolytic solution, a polar aprotic organic solvent may be used (utilized), and examples of the polar aprotic organic solvent are N-methyl-2-pyrrolidone, propylene carbonate, ethylene carbonate (EC), butylene carbonate (BC), dimethyl carbonate (DMC), diethyl carbonate (DEC), ethyl methyl carbonate (EMC), gamma-butyrolactone (GBL), 1,2-dimethoxy ethane (DME), tetrahydrofuran (THF), 2-methyltetrahydrofuran, dimethyl sulfoxide (DMSO), 1,3-dioxolane (DOL), formamide, dimethylformamide, acetonitrile, nitromethane, methyl formic acid, methyl acetic acid, phosphate triester, trimethoxylmethane, dioxolane derivatives, sulfolane, methyl sulfolane, 1,3-dimethyl-2-imidazolidinone, propylene carbonate derivatives, tetrahydrofuran derivatives, ethers, methyl propionic acid, ethyl propionic acid, etc.

Non-limiting examples of the organic solid electrolyte include polyethylene derivatives, polyethylene oxide derivatives, polypropylene oxide derivatives, phosphate ester polymer, polyagitation lysine, polyester sulfide, polyvinyl alcohol, vinylidene polyfluoride, polymers having an ionic dissociable group, etc.

Non-limiting examples of the inorganic solid electrolyte include nitrides, halides, and sulfates of Li, such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, or the like.

The lithium salt may be any one of various suitable lithium salts that are used (utilized) in lithium batteries. As a material that may be dissolved well in the non-aqueous electrolyte, for example, one or more of LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, lower aliphatic carbonic acid lithium, 4-phenyl boric acid lithium, lithium imide, etc. may be used (utilized).

Also, to form an SEI layer on a surface of the negative electrode and maintain the same on the surface of the negative electrode, vinylene carbonate (VC), catechol carbonate (CC), or the like may be included. Optionally, the electrolyte may include a redox-shuttle additive such as n-butyl ferrocene or halogen-substituted benzene to prevent (reduce or prevent) overcharging. Optionally, the electrolyte may include an additive for forming a film such as cyclohexyl benzene or biphenyl. Optionally, the electrolyte may include a cation receptor (such as a crown ether-based compound) and an anion receptor (such as a boron-based compound). Optionally, the electrolyte may include a phosphate compound (such as trimethyl phosphate (TMP), tris(2,2,2-trifluoroethyl)phosphate (TFP), or hexamethoxy cyclotriphosphazene (HMTP)) that may be included as a flame retardant.

When desired, the electrolyte may include an additive such as tris(trimethylsilyl)phosphate (TMSPa), lithium difluoro oxalato borate (LiFOB), propane sultone (PS), succinonitrile (SN), LiBF₄, a silane compound having a functional group (such as acryl, amino, epoxy, methoxy, ethoxy, or vinyl) that is capable of forming a siloxane bond, or a silazane compound (such as hexamethyldisilazane, for example, PS, SN, and LiBF₄).

For example, lithium salts such as LiPF₆, LiClO₄, LiBF₄, or LiN(SO₂CF₃)₂ may be added to a mixed solvent containing a cyclic carbonate such as EC or PC (which is a highly dielectric solvent) and a linear carbonate such as DEC, DMC, or EMC (which is a low viscosity solvent) to prepare an electrolyte.

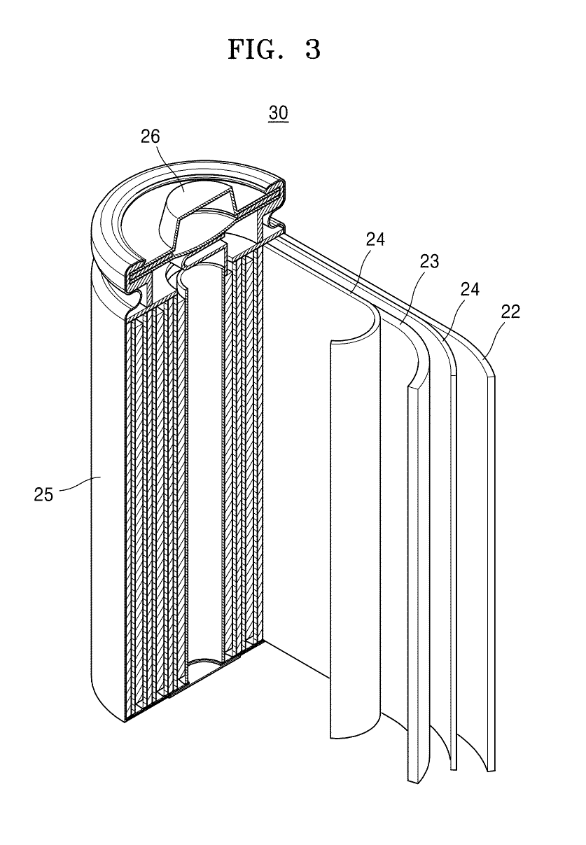

FIG. 3 is a schematic cross-sectional perspective view of a structure of a lithium battery 30 according to an embodiment.

Referring to FIG. 3, the lithium battery 30 includes a positive electrode 23, a negative electrode 22, and a separator 24 between the positive and negative electrodes 22 and 23. Also, the separator 24 may be further included on an external surface of the positive electrode 23 or the negative electrode 22 to prevent (reduce or prevent) internal short circuits. The positive electrode 23, the negative electrode 22, and the separator 24 are wound or folded, and housed in a battery case 25. Then, an electrolyte is injected into the battery case 25, followed by sealing the battery case 25 with an encapsulation member 26 to complete manufacture of the lithium battery 30. The battery case 25 may be a cylindrical case, a rectangular case, or a thin film case. The lithium battery 30 may be a lithium ion battery.

A lithium secondary battery may be categorized into a winding type or a stack type according to the shape of the electrode assembly; or cylindrical, rectangular, or pouch type according to the shape of the exterior battery case.

The lithium battery 30 may not only be utilized as a power source of a small device, but also as a unit battery of a battery module (which includes a plurality of unit batteries) for a medium to large-sized device.

Examples of a battery module for a medium to large-sized device include power tools; xEVs including electric vehicles (EVs), hybrid electric vehicles (HEVs), and plug-in hybrid electric vehicles (PHEVs); electric motorcycles including E-bikes and E-scooters; electric golf carts; electric trucks; electric commercial vehicles; and electric power storage systems, but the medium to large-sized battery module device is not limited thereto. Furthermore, the lithium battery 30 may be used (utilized) in any device requiring a high capacity battery, high-power output, and high temperature operability.

Hereinafter certain embodiments of this disclosure will be described with reference to examples and comparative examples. However, the examples are presented for illustrative purposes only and do not limit the scope of the disclosure.

### Preparation of a Positive Active Material

### Example 1

100 parts by weight of Li[Ni_{0.85}Co_{0.10}Mn_{0.05}]O₂ powder (product of Ecopro; Cheongju City, Korea) having an average diameter of 12 μm was dispersed in 95 parts by weight of distilled water. 1 part by weight of NH₄F (a product of Aldrich, St. Louis, USA) was added to 5 parts by weight of distilled water and then dissolved to prepare a coating solution. The coating solution was added to distilled water in which the Li[Ni_{0.85}Co_{0.10}Mn_{0.05}]O₂ powder was dispersed, stirred in a stirrer (a product of KM Tech; Hwaseong City, Korea) for 1 hour to coat a surface of the Li[Ni_{0.85}Co_{0.10}Mn_{0.05}]O₂ powder with NH₄F. The Li[Ni_{0.85}Co_{0.10}Mn_{0.05}]O₂ powder coated with NH₄F was dried at a temperature of 100° C. for 12 hours to prepare a positive active material in which a coating layer including LiF was formed.

### Example 2

A positive active material was prepared as in Example 1, except that the Li[Ni_{0.85}Co_{0.10}Mn_{0.05}]O₂ powder coated with NH₄F was dried at a temperature of 100° C. for 12 hours and heated in an air atmosphere at a temperature of 300° C. for 5 hours to prepare a positive active material in which a coating layer including LiF was formed.

### Example 3

A positive active material was prepared as in Example 1, except that the Li[Ni_{0.85}Co_{0.10}Mn_{0.05}]O₂ powder coated with NH₄F was dried at a temperature of 100° C. for 12 hours and heated in an air atmosphere at a temperature of 500° C. for 5 hours to prepare a positive active material in which a coating layer including LiF was formed.

### Example 4

A positive active material was prepared as in Example 1, except that the Li[Ni_{0.85}Co_{0.10}Mn_{0.05}]O₂ powder coated with NH₄F was dried at a temperature of 100° C. for 12 hours and heated in an air atmosphere at a temperature of 700° C. for 5 hours to prepare a positive active material in which a coating layer including LiF was formed.

### Example 5

A positive active material was prepared as in Example 4, except that 3 parts by weight of NH₄F was used instead of 1 part by weight of NH₄F.

### Example 6

A positive active material was prepared as in Example 1, except that (NH₄)₂HPO₄ was used instead of NH₄F to prepare a positive active material in which a coating layer including Li₃PO₄ was formed.

### Example 7

A positive active material was prepared as in Example 2, except that (NH₄)₂HPO₄ was used instead of NH₄F to prepare a positive active material in which a coating layer including Li₃PO₄ was formed.

### Example 8

A positive active material was prepared as in Example 3, except that (NH₄)₂HPO₄ was used instead of NH₄F to prepare a positive active material in which a coating layer including Li₃PO₄ was formed.

### Example 9

A positive active material was prepared as in Example 4, except that (NH₄)₂HPO₄ was used instead of NH₄F to prepare a positive active material in which a coating layer including Li₃PO₄ was formed.

### Example 10

A positive active material was prepared as in Example 5, except that (NH₄)₂HPO₄ was used instead of NH₄F to prepare a positive active material in which a coating layer including Li₃PO₄ was formed.

### Comparative Example 1

Li[Ni_{0.85}Co_{0.10}Mn_{0.05}]O₂ powder was used as a positive active material.

### Comparative Example 2

Li[Ni_{0.85}Co_{0.10}Mn_{0.05}]O₂ powder was heat treated at a temperature of 300° C. for 5 hours in an air atmosphere to prepare a positive active material.

### Comparative Example 3

Li[Ni_{0.85}Co_{0.10}Mn_{0.05}]O₂ powder was heat treated at a temperature of 500° C. for 5 hours in an air atmosphere to prepare a positive active material.

### Comparative Example 4

Li[Ni_{0.85}Co_{0.10}Mn_{0.05}]O₂ powder was heat treated at a temperature of 700° C. for 5 hours in an air atmosphere to prepare a positive active material.

### Comparative Example 5

A positive active material was prepared as in Example 2, except that polyvinylidene difluoride (PVDF) was used instead of NH₄F.

### Comparative Example 6

A positive active material was prepared as in Example 3, except that PVDF was used instead of NH₄F.

### Evaluation Example 1

### Measurement of the Amount of Free Lithium in the Positive Active Material

The amounts of the free lithium in the positive active materials of Examples 1-10 and Comparative Examples 1-6 were measured according to pH titration as described below.

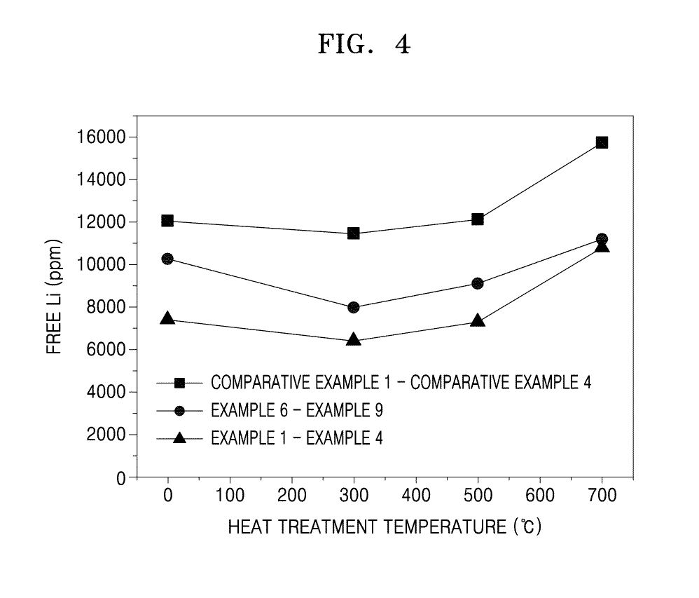

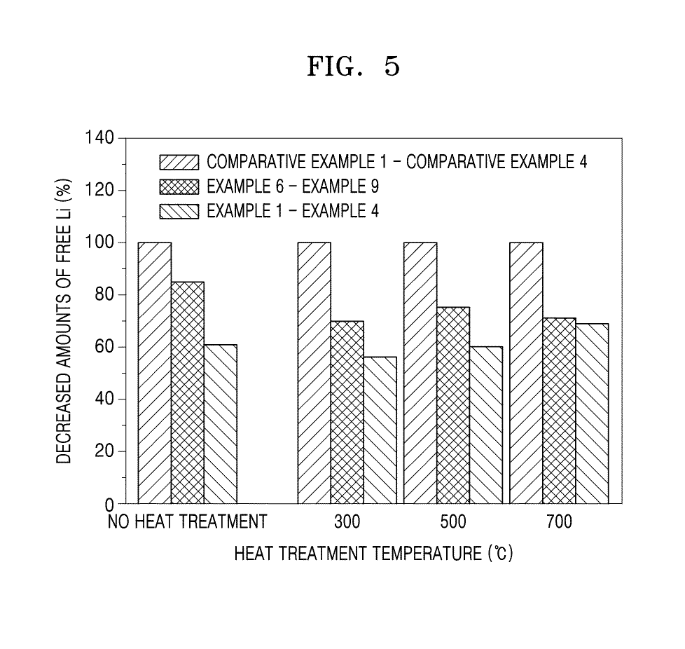

The positive active materials were dissolved in water, and then, the mixed solution was titrated with hydrochloric acid to calculate an amount of LiOH and Li₂CO₃ included in the positive active materials. Afterwards, an amount of the free lithium on the surface of the positive active materials was calculated therefrom, and the results are shown in Table 1 below and FIG. 4. The results of measuring amounts of free lithium according to temperatures of heat treatment performed on the positive active materials of Examples 1-4, Examples 6-9, and Comparative Examples 1-4 are shown in FIG. 5.

TABLE 1

| | Amount of Li₂CO₃ | Amount of LiOH | Amount of free |
|---|---|---|---|
| | (ppm) | (ppm) | lithium (ppm) |
| Comparative | 6,121 | 5,961 | 12,082 |
| Example 1 | | | |
| Comparative | 7,508 | 3,957 | 11,465 |
| Example 2 | | | |
| Comparative | 9,697 | 2,445 | 12,142 |
| Example 3 | | | |
| Comparative | 11,312 | 4,427 | 15,739 |
| Example 4 | | | |
| Comparative | 7,542 | 1,338 | 8,870 |
| Example 5 | | | |
| Comparative | 8,612 | 1,522 | 10,130 |
| Example 6 | | | |
| Example 1 | 5,257 | 2,159 | 7,416 |
| Example 2 | 4,183 | 2,226 | 6,409 |
| Example 3 | 4,041 | 3,263 | 7,304 |
| Example 4 | 6,718 | 4,089 | 10,806 |
| Example 5 | 4,988 | 2,669 | 7,657 |
| Example 6 | 8,502 | 1,783 | 10,285 |
| Example 7 | 7,081 | 927 | 8,008 |
| Example 8 | 7,762 | 1,348 | 9,110 |
| Example 9 | 7,968 | 3,259 | 11,227 |
| Example 10 | 5,102 | 4,315 | 9,417 |

As shown in Table 1 and FIGS. 4 and 5, it was found that as compared with the cases where the coating layers were not formed in the positive active materials of Comparative Examples 1-4, the amounts of the free lithium in the positive active materials of Examples 1-10 were significantly reduced. In this regard, it was confirmed that the free lithium on the surface of the Li[Ni_{0.85}Co_{0.10}Mn_{0.05}]O₂ powder was consumed to produce LiF and Li₃PO₄ by a reaction with each of the fluoride anion (F⁻) of NH₄F and the phosphate anion (PO₄³⁻) of (NH₄)₂HPO₄. That is, (without an additional washing process), regardless of using the lithium transition metal compound with a large amount of nickel, the chemical conversion of the free lithium to LiF or Li₃PO₄ showed that the positive active materials contained the free lithium in an amount of 10,000 ppm or less. In particular, the free lithium is more reactive to the fluoride anion than the phosphate anion, and thus, the free lithium was found to be more consumed when producing LiF rather than producing Li₃PO₄.

In addition, as shown in Table 1 and FIGS. 4 and 5, the amounts of the free lithium were reduced according to the temperatures of the heat treatment. In detail, as shown in FIG. 4, in the case where the heat treatment was not performed or in the case where the heat treatment was performed at a temperature of 500° C. or less, the amounts of the free lithium was 10,000 ppm or less. In particular, the amount of the free lithium was the greatest in the case where the heat treatment was performed at a temperature of 300° C., meaning that the free lithium was chemically converted to LiF or Li₃PO₄ the most actively at a temperature of 300° C. However, in the case where the positive active materials of Examples 4 and 9 were heat-treated at a temperature of 700° C., the amount of the free lithium was small, as compared with the case where the heat treatment was not performed or the case the heat treatment was performed at a temperature of 500° C. or less. That is, it was confirmed that at a temperature of 500° C. or more, lithium was deintercalated within the layered-structure of the lithium transition metal oxide. However, in the same case where the deintercalation of lithium occurred, the amount of the free lithium in the positive active materials of Examples 4 and 9 was still smaller than that of the free lithium in the positive active material of Comparative Examples 1-6. In particular, the amount of the free lithium in the positive active materials of Examples 4 and 9 was much smaller than that of the free lithium in the positive active material of Comparative Example 4 where the heat treatment was performed at a temperature of

700° C. and the coating layer was not formed.

In addition, as shown in Table 1, when the amounts of NH₄F and (NH₄)₂HPO₄ were increased from 1 part by weight to 3 parts by weight (Examples 4-5 and 9-10), the amounts of the free lithium were reduced by at least 2,000 ppm. That is, the amounts of the free lithium were reduced by at least 6,000 ppm as compared with the amount of the free lithium of Comparative Example 4. In this regard, it was confirmed that in the case of having increased amounts of NH₄F and (NH₄)₂HPO₄, a larger amounts of the free lithium was consumed for a reaction with each of F⁻ of NH₄F and PO₄³⁻ of (NH₄)₂HPO₄, thereby producing a larger amounts of LiF and Li₃PO₄.

In the case of Comparative Examples 5-6 where the positive active materials were heat-treated at a temperature of 500° C. and an organic material, e.g., PVDF, was used instead of inorganic materials such as NH₄F and (NH₄)₂HPO₄, the amount of the free lithium was at least 10,000 ppm. That is, the effect of using the organic material was insufficient to reduce the amount of the free lithium as compared with the effects of the positive active materials of Examples above.

### Evaluation Example 2

### Evaluation of Surface Properties of Positive Active Materials by XRD

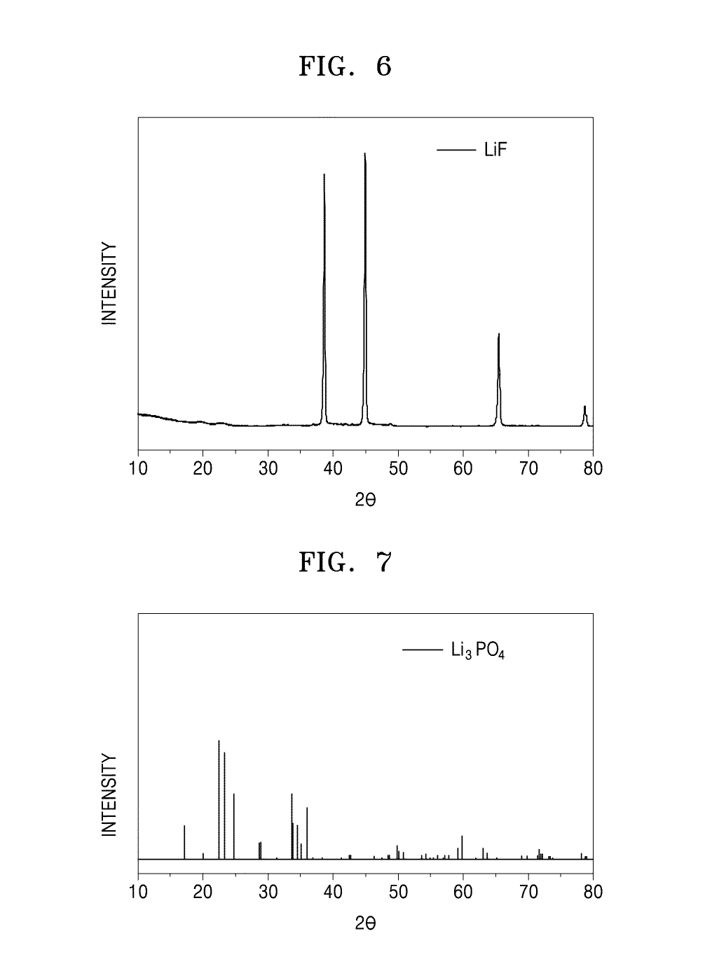

With respect to the positive active materials of Examples 1 and 6, XRD (X'pert PRO MPD, PANalytical B.V.) was used to analyze the phases of the positive active materials, and the results are shown in FIGS. 6 and 7. Here, XRD used Cu K-alpha characteristic X-ray (wavelength of 1.541 Å).

As shown in FIG. 6, in Example 1, the coating layer including LiF was formed, and that is, the free lithium on the surface of the Li[Ni_{0.85}Co_{0.10}Mn_{0.05}]O₂ powder had a reaction with NH₄F to produce LiF.

As shown in FIG. 7, in Example 6, the coating layer including Li₃PO₄ was formed, and that is, the free lithium on the surface of the Li[Ni_{0.85}Co_{0.10}Mn_{0.05}]O₂ powder had a reaction with (NH₄)₂HPO₄ to produce Li₃PO₄.

Although the heat treatment was not additionally performed, except the dry process for the removal of the solvent (e.g., distilled water), LiF and Li₃PO₄, which are stable lithium compounds, were produced.

### Evaluation Example 3

### Evaluation of Surface Properties of Positive Active Materials by XPS

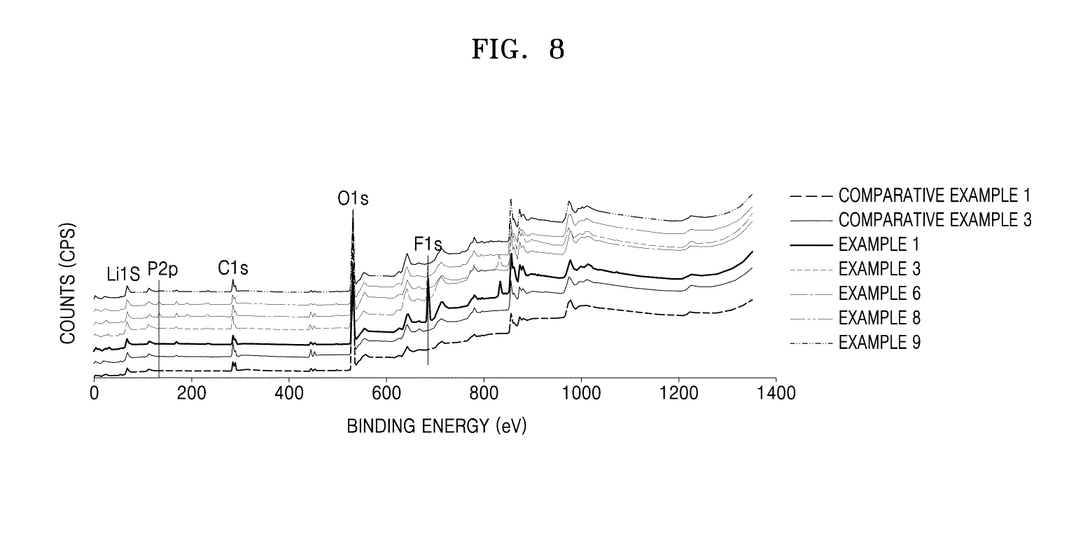

With respect to the positive active materials of Examples 1, 3, 6, 8, and 9, and Comparative Examples 1 and 3, XPS was used to measure the amounts of the elements contained in the coating layer of the positive active materials (unit: atomic percent (at %)). The XPS is one of qualitative analysis methods analyzing elements included in a sample by measuring the binding energy of photoelectrons, which is an inherent property of an atom. In greater detail, when an X-ray photon having a specific energy is applied to the sample, photoelectrons are emitted from the sample, and at this point, the kinetic energy of the photoelectrons is measured to detect the binding energy, which is needed to emit photoelectrons from the sample. The measurements are shown in Table 2 below and FIGS. 8-11.

TABLE 2

| | Comparative | Comparative | | | | | |
|---|---|---|---|---|---|---|---|
| (at %) | Example 1 | Example 3 | Example 1 | Example 3 | Example 6 | Example 8 | Example 9 |
| O 1s | 42.1 | 36.7 | 33.8 | 31.1 | 43.9 | 44.5 | 39.5 |
| Li 1s | 28.5 | 25.8 | 22.8 | 25.4 | 24.1 | 23.5 | 25.8 |
| C 1s | 22.8 | 26.3 | 16.0 | 18.9 | 15.9 | 17.2 | 20.7 |
| F 1s | 0 | 0 | 12.6 | 9.8 | 0 | 0 | 0 |
| P 2p | 0 | 0 | 0 | 0 | 3.1 | 2.5 | 1.1 |
| Ni 2p | 3.0 | 5.6 | 8.0 | 8.3 | 6.4 | 5.8 | 6.8 |
| Mn 2p | 2.0 | 3.6 | 3.6 | 4.0 | 3.1 | 3.3 | 3.7 |
| S 2p | 0.9 | 1.0 | 1.7 | 1.4 | 2.7 | 2.2 | 1.2 |
| Co 2p | 0.7 | 1.0 | 1.5 | 1.1 | 0.8 | 1.0 | 1.2 |

Referring to Table 2, it was confirmed that fluoride and phosphate were not detected in the positive active materials in which the coating layer was not formed. However, fluoride was detected in the positive active materials of Examples 1 and 3, meaning the production of LiF, and phosphate was detected in the positive active materials of Examples 6 and 8-9, meaning the production of Li₃PO₄.

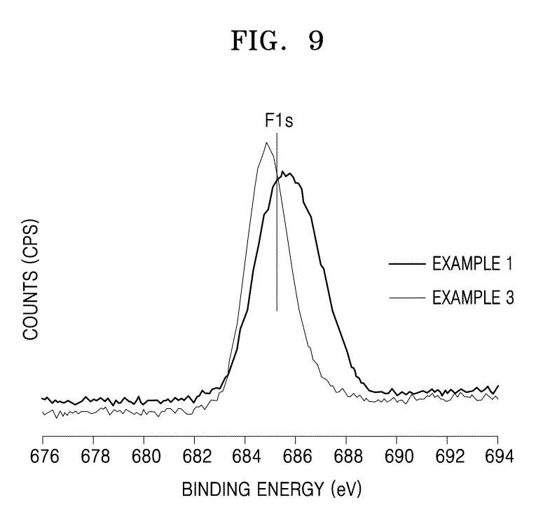

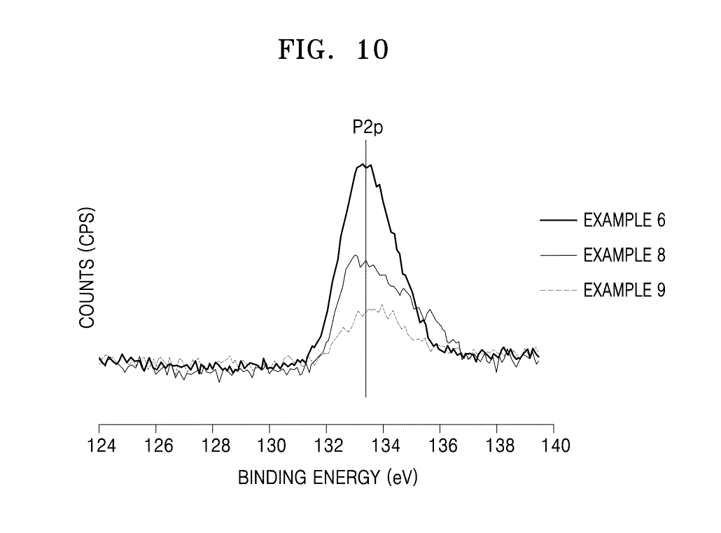

In detail, as shown in FIG. 9, a binding energy peak of photoelectrons emitted in a is orbital energy level of fluoride is measured by XPS with respect to the positive active materials of Examples 1 and 3, the binding energy peak appears at about 684 eV to about 686 eV. In addition, as shown in FIG. 10, a binding energy peak of photoelectrons emitted in a 2p orbital energy level of phosphate is measured by XPS with respect to the positive active materials of Examples 6, 8, and 9, the binding energy peak appears at about 133 eV to about 134 eV.

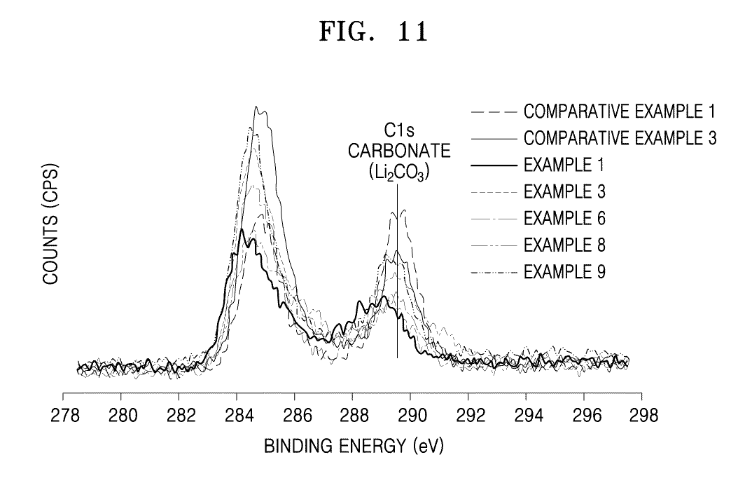

In particular, as shown in FIG. 11, as compared with the positive active material of Comparative Examples, the positive active materials of Examples above had a reduced amount of carbon, meaning that impurities (e.g., Li₂CO₃) on the surface of the lithium transition compound were reduced as well. That is, such reduced amounts refer to the chemical conversion of the free lithium to LiF and Li₃PO₄.

### Manufacture of a Positive Electrode and a Lithium Battery

### A Coin-Type Half Cell

### Example 11

### Preparation of a Positive Electrode

The positive active material of Example 2, PVDF as a binder, and a carbonaceous conductor (Denka Black) as a conductor were mixed at a weight ratio of 94:3:3, and N-methyl pyrrolidone was added in an amount of 60 wt % (of solids) to adjust the viscosity, thereby preparing a positive electrode slurry.

A coating of the positive electrode slurry having a thickness of 80 μm was formed on an aluminum current collector having a thickness of 15 μm by using a method generally known in the art. The aluminum current collector, on which the coating of the slurry was formed, was dried at room temperature, dried again at a temperature of 120° C., and then rolled and punched to prepare a positive electrode for use in a coin-type half cell.

### Preparation of a Lithium Secondary Battery

The positive electrode, lithium metal as a counter electrode, and a propylene separator having a thickness of 14 μm were used, and an electrolyte was injected therein, and the resultant was pressed to manufacture a 2032 standard coin cell. In this regard, the electrolyte was a solution in which LiPF₆ was dissolved to a concentration of 1.3 M in a mixed solvent of EC, DEC, and dimethyl carbonate (DMC) (a volume ratio of 3:4:3 of EC:EMC:DMC).

### Examples 12 to 16

Lithium secondary batteries are manufactured as in Example 11, except that the positive active materials of Examples 3-4 and 7-9 were used, respectively.

### Comparative Examples 7-12

Lithium secondary batteries are manufactured as in Example 11, except that the positive active materials of Comparative Examples 1-6 were used, respectively.

### Evaluation Example 4

### Evaluation of Discharge Rates

The lithium secondary batteries of Examples 11-16 and Comparative Examples 7-12 were charged at a charge current of 20 A, at a charge voltage of 4.3 V, and at a temperature of 25° C. under conditions of constant current-constant voltage (CC-CV). After having a 10 minutes pause, the lithium secondary batteries were discharged at a discharge current in a range of 0.2 C to 1.0 C and at a discharge cutoff voltage of 2.8 V. Then, a discharge capacity measured at a current of 0.2 C after performing charge/discharge cycles 5 times was used as a reference capacity, and discharge rates of the batteries at a current of 0.5 C, 0.7 C, and 1.0 C were measured and shown in Table 3 below. Here, the discharge rate may be defined by Equation 1 below.

Discharge rate (vs. 0.2 C) [%]=[Discharge capacity at a current of 1.0 C/Discharge capacity at a current of 0.2 C]×100 Equation 1

TABLE 3

| | Additive | Heat treatment | Discharge rate | |
|---|---|---|---|---|
| | compound for | temperature | (vs.0.2 C) (%) | |
| | coating | (° C.) | 0.2 C | 1.0 C |
| Comparative | — | — | 100 | 90.9 |
| Example 7 | | | | |
| Comparative | — | 300 | 100 | 90.3 |
| Example 8 | | | | |
| Comparative | — | 500 | 100 | 90.1 |
| Example 9 | | | | |
| Comparative | — | 700 | 100 | 90.4 |
| Example 10 | | | | |
| Comparative | PVDF | 300 | 100 | 91.4 |
| Example 11 | | | | |
| Comparative | PVDF | 500 | 100 | 90.8 |
| Example 12 | | | | |
| Example 11 | NH₄F | 300 | 100 | 93.0 |
| Example 12 | NH₄F | 500 | 100 | 92.9 |
| Example 13 | NH₄F | 700 | 100 | 93.2 |
| Example 14 | (NH₄)₂HPO₄ | 300 | 100 | 92.6 |
| Example 15 | (NH₄)₂HPO₄ | 500 | 100 | 93.1 |
| Example 16 | (NH₄)₂HPO₄ | 700 | 100 | 92.9 |

Referring to Table 3, the lithium secondary batteries of Examples above had improved high-rate discharge characteristics, regardless of heat treatment temperatures, as compared with the lithium secondary batteries of Comparative Examples above. In particular, the lithium secondary batteries of Examples above showed excellent discharge rates as compared with the lithium secondary batteries including the positive active materials in which the coating layer was formed by PVDF (Comparative Examples 11-12). Therefore, it was confirmed that the coating layer according to embodiments of the present disclosure enhanced high-rate characteristics of the battery.

### Evaluation Example 5

### Evaluation of Lifespan Properties at Room Temperature

The coin-cells of Examples 11-16 and Comparative Examples 7-12 were charged at a constant current of 0.1 C at a temperature of 25° C. until the voltage reached 4.3 V. Then, the coin cells were discharged at a constant current of 0.1 C until the voltage reached 2.8 V (formation process).

Then, the coin-cells were charged at a constant current of 0.2 C until the voltage reached 4.3 V, and then the coin-cells were charged at a constant voltage until the current reached 0.05 C while maintaining the voltage of 4.3 V. Thereafter, the coin cells were discharged at a constant current of 0.2 C until the voltage reached 2.8 V (rating process).

Lithium batteries to which the formation and rating processes were applied were charged at a constant current of 0.5 C at a temperature of 25° C. until the voltage reached 4.3 V, and then the lithium batteries were charged at a constant voltage until the current reached 0.05 C while maintaining the voltage of 4.3 V. Then, the charge and discharge cycle including discharging the lithium batteries at a constant current of 0.5 C until the voltage reached 3.0 V was repeated 30 times.

The capacities of the coin-type half-cells were measured, and the results are shown in FIG. 9 and Table 4 below. The CRR may be defined by Equation 2 below.

CPR [%]=[Discharge capacity in each cycle/Discharge capacity in the 1^{st} cycle]×100 Equation 2

TABLE 4

| | Additive | Heat treatment | | |
|---|---|---|---|---|
| | compound for | temperature | CPR (%) | |
| | coating | (° C.) | 10 times | 30 times |
| Comparative | — | — | 95 | 87 |
| Example 7 | | | | |
| Comparative | — | 300 | 96 | 87 |
| Example 8 | | | | |
| Comparative | — | 500 | 96 | 88 |
| Example 9 | | | | |
| Comparative | — | 700 | 95 | 87 |
| Example 10 | | | | |
| Comparative | PVDF | 300 | 96 | 92 |
| Example 11 | | | | |
| Comparative | PVDF | 500 | 92 | 89 |
| Example 12 | | | | |
| Example 11 | NH₄F | 300 | 99 | 97 |
| Example 12 | NH₄F | 500 | 99 | 97 |
| Example 13 | NH₄F | 700 | 99 | 97 |
| Example 14 | (NH₄)₂HPO₄ | 300 | 97 | 95 |
| Example 15 | (NH₄)₂HPO₄ | 500 | 99 | 97 |
| Example 16 | (NH₄)₂HPO₄ | 700 | 99 | 97 |

Referring to Table 4, the lithium secondary batteries of Examples above had improved CPR, regardless of heat treatment temperatures, as compared with the lithium secondary batteries of Comparative Examples above. In particular, the lithium secondary batteries of Examples above showed excellent CPR as compared with the lithium secondary batteries including the positive active materials in which the coating layer was formed by PVDF (Comparative Examples 11 and 12). Therefore, it was confirmed that the lifespan characteristics of the battery were degraded in the case where the amount of the free lithium exceeds 10,000 ppm.

### Evaluation Example 6

### Evaluation of Lifespan Properties at High Temperature

The half coin cells of Examples 11, 13, 14, and 16 and Comparative Examples 8, 11 and 12 were charged at a constant current of 0.5 C until the voltage reached 4.3 V, and then, the coin cells were left in a high-temperature oven at a temperature of 60° C. while maintaining the voltage of 4.3 V. Thereafter, the coin cells were discharged at a constant current of 1.0 C, so as to measure the remaining capacity and recovering capacity before and after the leaving the coin cell. These measurements are shown in Table 5.

TABLE 5

| | | | Discharge | Remaining | |
|---|---|---|---|---|---|
| | | Heat | capacity | capacity | Recovering |
| | Additive | treatment | before | after | capacity |
| | compound for | temperature | leaving | leaving | after leaving |
| | coating | (° C.) | (%) | (%) | (%) |
| Comparative | — | 300 | 100 | 85.9 | 89.1 |
| Example 8 | | | | | |
| Comparative | PVDF | 300 | 100 | 89.3 | 94.5 |
| Example 11 | | | | | |
| Comparative | PVDF | 500 | 100 | 88.4 | 92.9 |
| Example 12 | | | | | |
| Example 11 | NH₄F | 300 | 100 | 92.4 | 98.1 |
| Example 13 | NH₄F | 700 | 100 | 92.6 | 98.1 |
| Example 14 | (NH₄)₂HPO₄ | 300 | 100 | 91.5 | 98.2 |
| Example 16 | (NH₄)₂HPO₄ | 700 | 100 | 92.3 | 97.9 |

Referring to Table 5, the lithium secondary batteries of Examples above showed excellent lifespan characteristics, as compared with the lithium secondary batteries of Comparative Examples above. In particular, the lithium secondary batteries of Examples above showed excellent durability at a high temperature as compared with the lithium secondary batteries including the positive active materials in which the coating layer was formed by PVDF (Comparative Examples 11-12). It is considered that the contact between the core and the electrolyte is minimized due to the coating layer containing LiF and/or Li₃PO₄ and the stability of the positive active materials is improved due to reduced amount of the free lithium. The results showed that the free lithium in the amount exceeding 10,000 ppm caused degradation of lifespan characteristics of the battery at high temperatures.

As described above, the positive active material according to an exemplary embodiment may include a coating layer containing at least one of LiF and Li₃PO₄, which decreases an amount of free lithium included in the positive active material. Therefore, a lithium battery including the positive active material may have improved lifespan properties at room temperatures and high temperatures.

It should be understood that the example embodiments described herein should be considered in a descriptive sense only and not for purposes of limitation. Descriptions of features or aspects within each embodiment should typically be considered as available for other similar features or aspects in other embodiments.

In the present disclosure, the terms “Example,” “Comparative Example,” “Reference Example” “Manufacture Example,” “Comparative Manufacture Example,” “Reference Manufacture Example” and “Evaluation Example” are used arbitrarily to simply identify a particular example or experimentation and should not be interpreted as admission of prior art. While one or more embodiments have been described herein, it will be understood by those of ordinary skill in the art that various changes may be made to the described embodiments without departing from the spirit and scope of the present invention as defined by the following claims.

What is claimed is:

1. A positive active material comprising:
a core comprising a lithium metal composite oxide; and
a coating layer disposed on the core,
wherein the coating layer comprises at least one of lithium fluoride (LiF) and lithium phosphate (Li₃PO₄).

2. The positive active material of claim 1, wherein the positive active material comprises free lithium in an amount of 10,000 ppm or less based on a total weight of the positive active material.

3. The positive active material of claim 1, wherein the lithium metal composite oxide comprises a lithium-nickel composite oxide,
wherein the amount of nickel is at least 60 mole % based on a total number of moles of metal atoms except for lithium in the lithium-nickel composite oxide.

4. The positive active material of claim 1, wherein the lithium metal composite oxide comprises a lithium-nickel composite oxide represented by Formula 1:
Liₐ(NiₓM′_{y}M″_{z})O₂ Formula 1
wherein, M′ is at least one element selected from the group consisting of Co, Mn, Ni, Al, Mg, and Ti; and
M″ is at least one element selected from the group consisting of Ca, Mg, Al, Ti, Sr, Fe, Co, Mn, Ni, Cu, Zn, Y, Zr, Nb, and B,
0.8<a≦1.2, 0.6≦x≦1, 0≦y≦0.4, 0≦z≦0.4, and x+y+z≦1.2.

5. A positive electrode comprising the positive active material according to claim 1.

6. A lithium battery comprising the positive electrode according to claim 5.

7. A method of preparing the positive active material according to claim 1, the method comprising:
providing a core that comprises a lithium metal composite oxide comprising free lithium; and
coating a surface of the core with at least one of a fluoride compound and a phosphate compound to form a coating layer comprising at least one of LiF and Li₃PO₄.

8. The method of claim 7, wherein LiF is a resultant product of a reaction between the free lithium and the fluoride compound and Li₃PO₄ is a resultant product of a reaction between the free lithium and the phosphate compound.

9. The method of claim 7, wherein the fluoride compound is selected from NH₄F, NH₄HF₂, NH₄PF₆, AlF₃, MgF₂, CaF₂, MnF₃, FeF₃, CoF₂, CoF₃, NiF₂, TiF₄, CuF, and ZnF₂, or a combination thereof, and the phosphate compound is selected from NH₄H₂PO₄, (NH₄)₂HPO₄, P₂O₃, P₂O₅, H₃PO₄, MgHPO₄, Mg₃(PO₄)₂, Mg(H₂PO₄)₂, NH₄MgPO₄, AlPO₄, FePO₄, and Zn₃(PO₄)₂, or a combination thereof.

10. The method of claim 7, further comprising, after forming the coating layer, heat-treating the core on which the coating layer is formed.
